(19) United States
(12) Patent Application Publication
(10) Pub. No.: US 2003/0123626 A1
(43) Pub. Date: Jul. 3, 2003

(54) Method and apparatus for handling to an incoming call

(76) Inventors: John Beckmann, Del Mar, CA (US); Thomas Winkler, Vancouver (CA)

Correspondence Address: Brian Rivers, Patent Department, % Milan Patel, Nokia Mobile Phones, 6000 Connection Drive, Irving, TX, 75039, US

(21) Appl. No.: 10/033,128

(22) Filed: Dec. 27, 2001

(51) Int. Cl. H04M 11/00

(52) U.S. Cl. 379/93.35

(57) ABSTRACT

The present invention is directed to a method and apparatus for handling an incoming call request. An auto notification feature is provided, such that the user is able accept an incoming call request and immediately place calling party on hold. A greeting is provided to the calling party to notify that the calling party is unable to talk due to present circumstances and request the calling party to hold until the called party is able to talk.

### FIELD OF THE INVENTION

The present invention relates to an electronic device used in a communication system having a method of answering an incoming call, more particularly, to a method and apparatus for providing a delay upon accepting an incoming call request.

### BACKGROUND OF THE INVENTION

A communication system is operable to communicate information between a transmitting station (a calling party) and a receiving station (a called party) by way of a communication connection. A wireless communication system is a communication system in which information is communicated between the transmitting and receiving stations via one or more base stations. A cellular or digital communication system is exemplary of a multi-user wireless communication system.

Various wireless communication systems have been developed and implemented throughout large geographical areas. Various standards have been established, and the wireless communication systems are generally constructed to be operable in compliance with one or more of the standards. One such standard, referred to as IS-95/IS-2000 defines a CDMA (Code Division Multiple Access) based wireless communication system. In a wireless communication system such as CDMA, defined by IS-95/IS-2000 standard, a call is established between the called party and the calling party via a communication link. The calling party initiates the call by using a calling sequence by sending an outgoing call request which includes, for example, an Origination Message defined in “Upper Layer (Layer 3) Signaling Standard for CDMA2000 Spread Spectrum Systems” published as TIA/EIA/IS-2000-5-A, 2000, herein referred to as IS-2000A standard. The called party having a ringing sequence receives an incoming call request, which includes a General Page Message defined in the IS-2000A standard. Upon the called party's receiving the call request, the user may accept said incoming call request and thereafter a communication link is established.

Generally, upon receiving an incoming call request by the calling party, the called party checks the display to determine the caller's id and either chooses to accept or not to accept the incoming call request. However, there are situations wherein upon accepting the call the user is not able to communicate with called party. For example, if the user is in a meeting, at a movie theater, driving an automobile, riding a bicycle or in a conversation with other colleagues. Generally in these types of situations, user may wish to accept the call, however it would be rude or dangerous to just began talking immediately upon accepting the call request. In this situation, the user would have to quickly step away from the meeting or rudely interrupt someone to accept the before the call request is forwarded to voice mail or before call request is terminated. If the called party accepts the call request and is not able to talk for few seconds, then the called party is being rude to the calling party, which may cause the called party to terminate the call.

Therefore, it would be useful if the user can accept a call, notify the calling party of the situation without being rude to the surround people and placing the established call on hold until the called party is able to communicate with the called party. For example, accept the call request then quietly stepping outside of a meeting and then talk to the called party. It would also be useful if the called party was notified that the called party has accepted the call request but is not able to communicate immediately for reason.

### SUMMARY OF THE INVENTION

The present invention advantageously provides an apparatus and an associated method, for an electronic device to adequately process an incoming call wherein the user is not able to talk, immediately upon accepting the incoming call.

The present invention encompasses an electronic device, such as a mobile terminal, a personal digital assistant (PDA) or a portable computer, which may be operated in a communication system (for example CDMA, TDMA, GSM, etc.). The electronic device comprises a method of processing an incoming call.

The electronic device comprises method of receiving an incoming call request by the called party. Upon receiving an incoming call request, the called party may accept the incoming call, by providing input at the electronic device. For example, actuating a single key at the electronic device or providing input sequence. Upon accepting the incoming call request, a communication link is established. Once the communication link is established, a greeting may be provided to the calling party, generally indicating to the calling party that the user is not able speak immediately and requests the calling party to hold for few seconds. The call is then placed on hold mode until user is able to converse with the called party. For example, a mute function of the electronic device is activated to place the call on hold and deactivated upon the user providing another input.

Providing the greeting to notify the called party of the circumstances of the called party and placing the established call on hold, advantageously allows the called party to accept the call request and have time to find a location where a conversation may be carried out. Upon finding such location, the called party may release the hold by providing a second input at the electronic device.

A more complete appreciation of all the advantages and scope of the present invention can be obtained from the accompanying drawings, the following detailed description of the invention, and the appended claims.

### BRIEF DESCRIPTION OF THE DRAWINGS

FIG. 1 illustrates a block diagram of a mobile terminal into which an embodiment of the invention may be implemented;

FIG. 2 shows software module of an auto notification setup task, depiction of an embodiment of the invention;

FIG. 3 shows software module of an auto notification task, depiction of an embodiment of the invention;

FIG. 4 shows software module of a determine greeting task, depiction of an embodiment of the invention;

FIG. 5 shows software module of an execute the greeting task, depiction of an embodiment of the invention; and

FIG. 6 shows software module of an execute the action task, depiction of an embodiment of the invention.

### DETAILED DESCRIPTION OF THE INVENTION

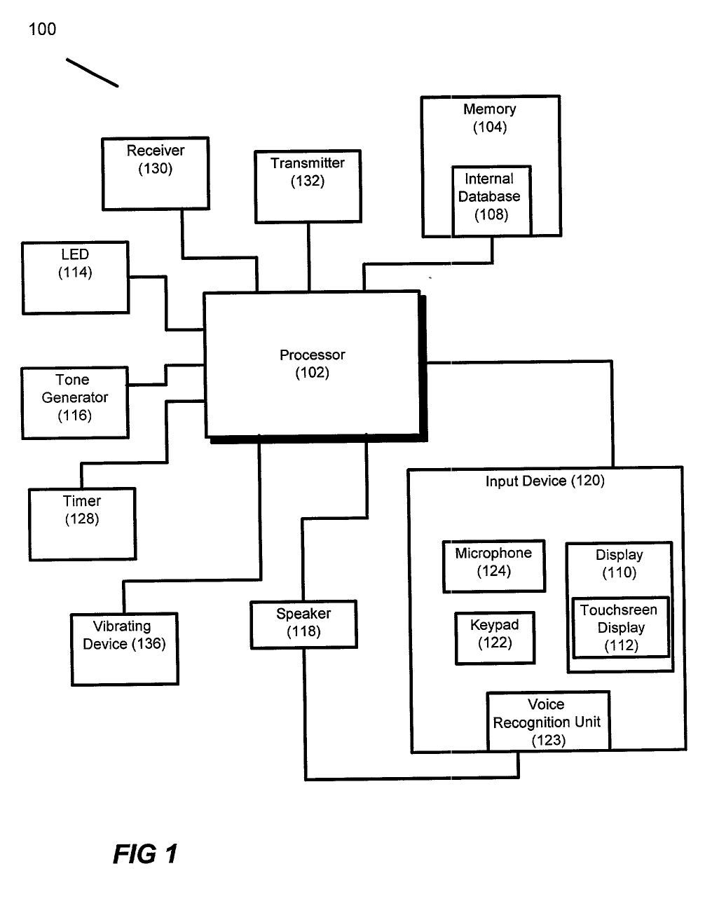

FIG. 1 is a block diagram of the electronic device, such as a mobile terminal 100, according to an embodiment of the invention. Generally, the mobile terminal 100 includes a controller 102 (which may also be known as a processor) coupled to various memories, collectively shown as memory 104. Memory 104 includes a plurality of stored constants and variables that are used by processor 102 during the operation of the electronic device 100. For example, memory 104 stores the values of the various feature parameters and the Number Assignment Module (NAM). An operating program for controlling the operation of processor 102 is also stored in memory 104 (typically in a read only memory). Memory 104 is also used to store data provided by the user through the user interface. Furthermore, memory 104 is used to hold the subprograms or sub-processes for controlling the operation of mobile terminal 100 and carrying out the embodiment of the invention. The operating program in memory 104 includes routines for handling the incoming call according to the invention.

The user interface of the mobile terminal 1100 also includes a Liquid Crystal Display (LCD) 110, a touch-screen display 112, Light Emitting Diode (LED) 114, tone generator 116, speaker 118, user input device 120, all of which are coupled to processor 102. The user input device 120 comprises an alphanumeric keypad 122 (including “★”, “#”, “talk” and “end” keys) and a voice recognition unit 123 for providing input to the processor 102. The input device may also comprise microphone 124 and the touch screen display 112 for generating input. Mobile terminal 100 also comprises timer 128 (also referred to as a clock chip) coupled to processor 102 for synchronizing the operations of processor 102 and tracking time.

The exemplary mobile terminal 100 also includes a receiver 130, transmitter 132, coupled to the processor 102. The processor 102, coupled to the transmitter 132 and the receiver 130, initiates the transmission of outgoing signals and processes incoming signals, respectively. These signals may include signaling information in accordance with the air interface of the applicable cellular or digital system and also user speech and/or user generated data.

In an exemplary implementation of an electronic device, analogous to the mobile terminal 100, using the menu feature of the mobile terminal 100, the user may setup the auto notification feature and associated parameters. The parameter, for example greeting parameters, may be stored in memory 104, generally in the internal database 108.

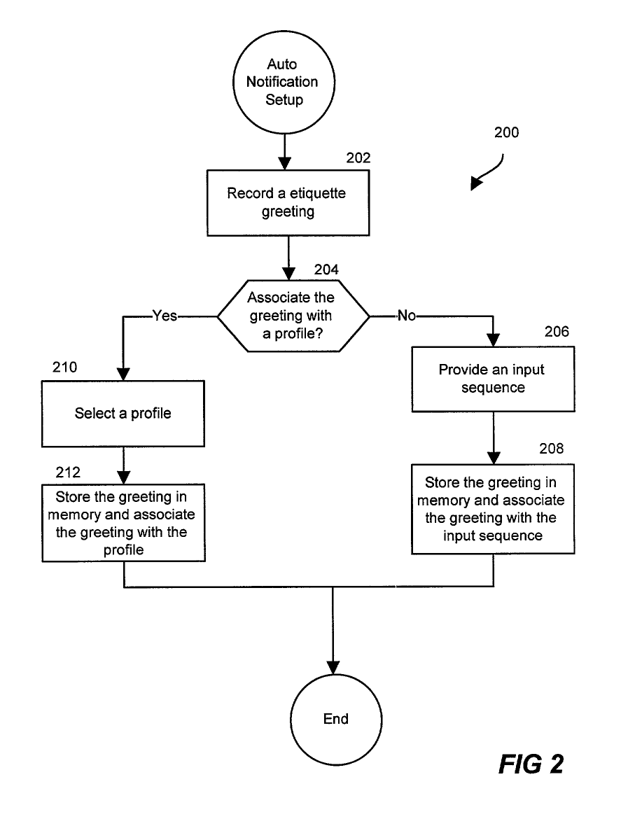

FIG. 2 describes an auto notification setup task 200 accordance to an embodiment of the invention. At block 202, the user of the electronic device may record a new greeting or download the new greeting from the external database. At block 204, the processor 102 requests to user to select a method of storing the greeting. If the user selects to associate the new greeting with one of the profiles, then at 210 the processor 102 allows the user to select a profile. At block 212, the processor 102 stores the greeting in the internal database 108 and associates the greeting to the selected profile.

If the user does not elect to associate the greeting to a profile, then at block 206, the user is requested to provide an input sequence. The input sequence may comprise a single key. The input sequence may also be sequence beginning with a prefix key (for example, “#” or “★” key) followed by one or more suffix keys (for example, any alphanumeric keys). The suffix keys may represent memory location where the predefined greetings are stored. For example, if user provides the input sequence that starts with the prefix key followed by one or more suffix keys, then the greeting will be associated with suffix keys (for example, the greeting will be associated with the greeting stored in memory location).

User may also actuate a designated answer key or keys, for example the “talk” key, whereby the greeting will be associated with any key that accepts the incoming call. Regardless of the input sequence selected by the user, at block 208, the processor 102 store the greeting in memory and associates the greeting with the input sequence. This setup will allow the user to accept the incoming call either by actuating a single key or actuating a sequence of keys to provide the associated greeting to the called party.

In addition to recording new greetings, the user may record download additional greetings from external database or may modify existing greetings by using the menu feature of the mobile terminal 100. The user may activate the auto notification feature upon setting up the greetings. Once the auto notification feature is activated, the processor 102 monitors for incoming call.

In an operation of the invention, once the greetings have been set up, the user activates the auto notification feature. When a call request is received at the mobile terminal 100, the user may check the display to determine calling party identification. If the user wishes to accept the call request, then user accepts the incoming call request by providing a first input at the mobile terminal (for example actuating a “talk” key or ★12). Once the user accepts the incoming call request, the processor 102, determines the greeting based on the first input, establishes a communication link (also referred to as a call), provides the greeting to the calling party, puts the call on hold and waits for additional input from the user. When the user is ready, the user may provide the additional input to release the call hold or terminate the call. This operation advantageously allows the user necessary delay in having to converse immediately upon accepting the call request.

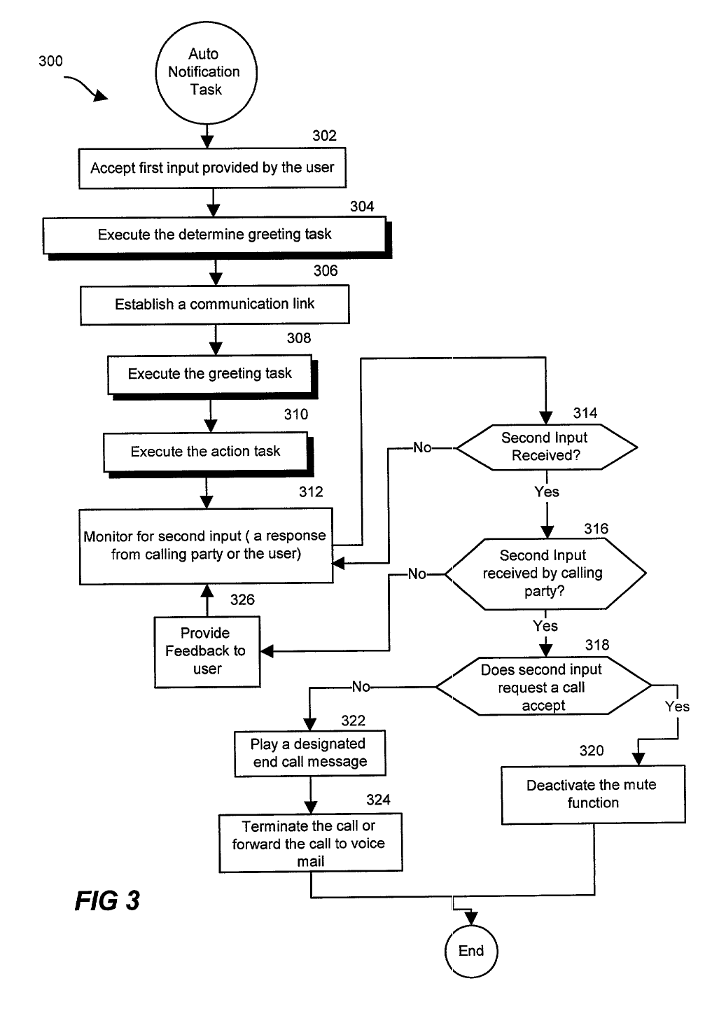

Referring now to FIG. 3 which describes an auto notification task 300 accordance to an embodiment of the invention. This task is activated upon the mobile terminal receiving an incoming call request while the auto notification feature is activated. At block 302, the processor 102 accepts the first input, provided by the user, generally using a keypad 122, to accept the incoming call request. As stated above, the first input may be an actuation of a single key or an input sequence comprising actuation of plurality of keys of the keypad 122. At block 304, the process executes a determine greeting task to determine which greeting is to be provided to called party based on the first input received in block 302. If the user did not override the auto notification feature by providing a long press input (describe below), then at block 306, the processor establishes a communication link (the call) between the called party and the calling party.

Based on the type of greeting determined, at block 308 the processor 102 processes an execute the greeting task. As described in detail below, the execute the greeting task will execute the greeting associated with the first input. Upon providing the greeting to the called party, at block 310, the processor 102 processes an execute the action task to execute the determined action based on the first input. This task will either end the call properly or place the call on hold. If in block 310 the call is placed on hold, then at block 312, the processor 102 monitors for a second input and maintains the mute function until the second input is received.

The user or the calling party may provide the second input. While the processor monitors for second input. At block 314 the processor determines if the second input was received, at the mobile terminal 100, via the input device 120. The user via the input device 120 may provide the input, for example the user is able to converse with the called party. Also, the calling party may provide the second input at mobile terminal. Generally, if the calling party has an emergency and can not wait for the called party to find proper location. The calling party, for example, may provide key tones or voice feedback. Depending on the manufacturer, the processor 102 may monitor any electronic pulses at the speaker to determine if the calling party has provided any input. If the calling party has provided the second input, then at block 326, an alert function is activated and the user of the mobile terminal 100 is provided an alert. The alert may be in a form voice, text message displayed on the display 110, vibrate alert, key tones generated using tone generator 116, etc. Accepting a second input from the called party advantageously allows the calling party to communicate with the called party while the call is on hold. For example, the calling party may notify the called party of an emergency, which requires immediate attention. Upon providing the feedback, the processor 102 continues monitoring for input from the user of the mobile terminal 100.

If determined, at block 316, that the second input was received from the user of the mobile terminal 102, then at block 318, the processor analyzes the second input to determine if the user has accepted the call or decided to terminate the call. The user may accept the call by actuating a designated call answer key, for example the “talk” key. The user may terminate the call by pressing the “end” key. At block 318, if the second input indicates an acceptance of the call then block 302 is executed and the processor 102 deactivates the mute function to release the hold on the call thereby allowing the user to converse with calling party. Otherwise, if the second input indicates a call termination, then at block 322, a prerecorded end call greeting may be provided to the calling party. At block 324, if the mobile terminal has a voice mail feature, then the call is forwarded to the voice mail. Otherwise, the call is terminated.

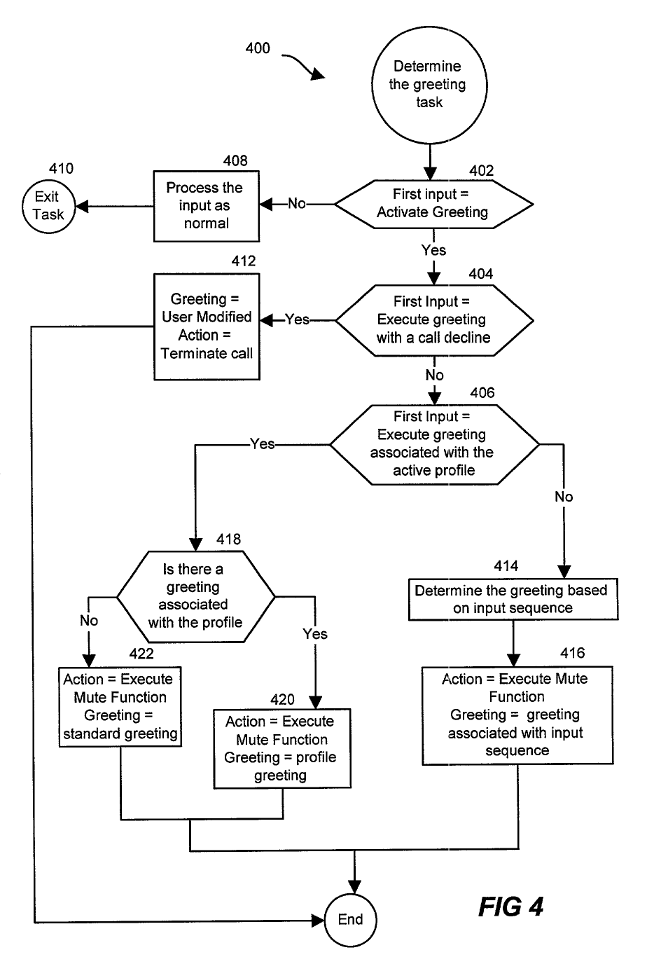

FIG. 4 describes a determine greeting task 400 accordance to an embodiment of the invention. This task is activated upon the user accepting the incoming call. Generally, the purpose of this task is to set up the greeting and action parameters. At block 402, the processor 102 determines if any greeting need to be activated. For example, when the user wishes to accept the call and immediately start conversing with called party, the user may provide a long press “talk” or “end” key as first input. This type of input will override the auto notification feature. Occasionally, the user may want override the auto notification feature because the user is able to converse immediately upon accepting the incoming call or does not wish to accept the call. If the user provides an input that overrides the auto notification feature, then at block 408, the call is processed as normal and at block 408 the processor exits the auto notification task.

The user may provide first input without overriding the auto notification feature by actuating keys of keypad 122 without a long press. If so, then processor 102 executes block 404. At block 404, if the user has actuated the designated call termination key (for example the “end” key) then the processor 102 determines the first input as providing greeting with a call termination and executes block 412. At block 412, the processor sets the greeting parameter and the action parameter. To set the greeting parameter, the user may be prompted to select a greeting from a list of greetings or select the greeting that is associated with the active profile. The greeting parameter is set to be user selected greeting and the action parameter is set to terminate the call.

Referring back to block 404, if the user actuates designated accept key, generally the “talk” key, then the processor 102 determines the first input as providing greeting without terminating the call and executes block 406. At block 406, the processor evaluates the first input to determine if an input sequence was provided or a designated accept key. If the designated accept key was received as input, then block 418 is executed. At block 418, if the processor determines that a greeting is associated with the active profile then at block 420, the greeting parameter is set to provide profile associated greeting and the action parameter is set to execute the mute function. Otherwise, at block 420, the greeting parameter is set to provide a standard greeting and action is set to execute the mute function.

If determined, at block 406, that an input sequence was provided, then blocks 414 and 416 are executed. At block 414, the processor determines the greeting associated with the input sequence. At block 416, the greeting parameter is set to provide greeting associated with the input sequence and the action parameter is set to execute the mute function.

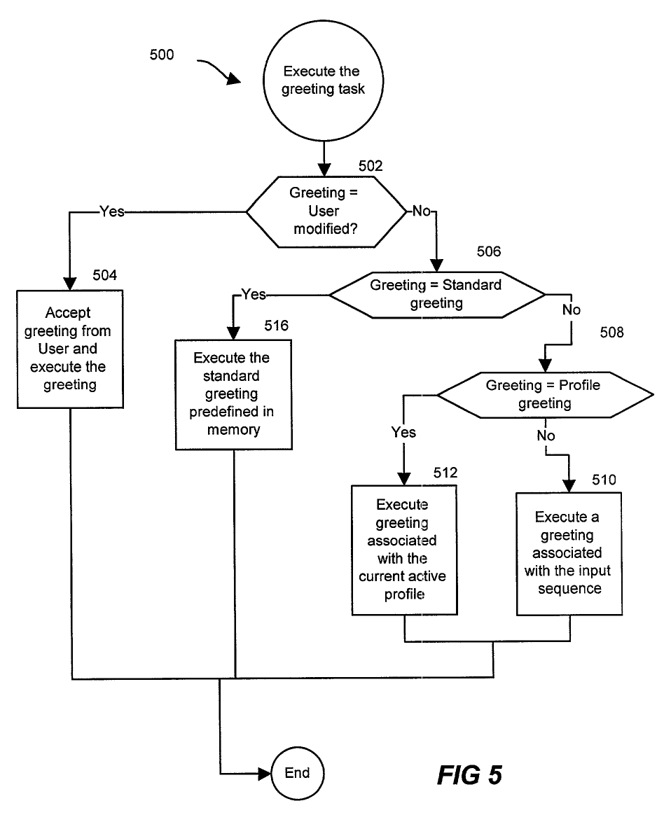

FIG. 5 describes an execute greeting task 500 accordance to an embodiment of the invention. This task is executed after determining the greeting parameters and is executed from block 308 of the auto notification task 300 described above. The purpose of this task is to evaluate the greeting parameter and to execute the greeting associated with the greeting parameters set within the determine greeting task 400. At block 502, if the processor 102 determines the greeting parameter was set to user selected greeting, then at block 504, the processor 102 retrieves the user selected greeting and provides the user selected greeting, using the communication link, to the called party. Otherwise, at block 506, if the processor 102 determines the greeting parameter is set to standard greeting then, at block 516, the processor 102 provides the standard greeting to the calling party. If the processor 102 determines, at block 506, the greeting parameter is not set to standard greeting, then block 508 is executed. At block 508, if the processor determines that the greeting parameter is set to profile associated greeting, then the processor 102 provides the greeting associated with the current active profile to the calling party, at block 512. Otherwise, the processor provides the greeting associated with input sequence, at block 510. It should be noted that all the greetings are transmitted to the calling party using the established communication link. Generally, the greetings, stored in internal database 108, are digital audio files. To reduce the amount of voice data transmission, the greetings may be stored or converted to digital format using efficient compression algorithms, such as MPEG 1 Audio Layer 3 (MP3).

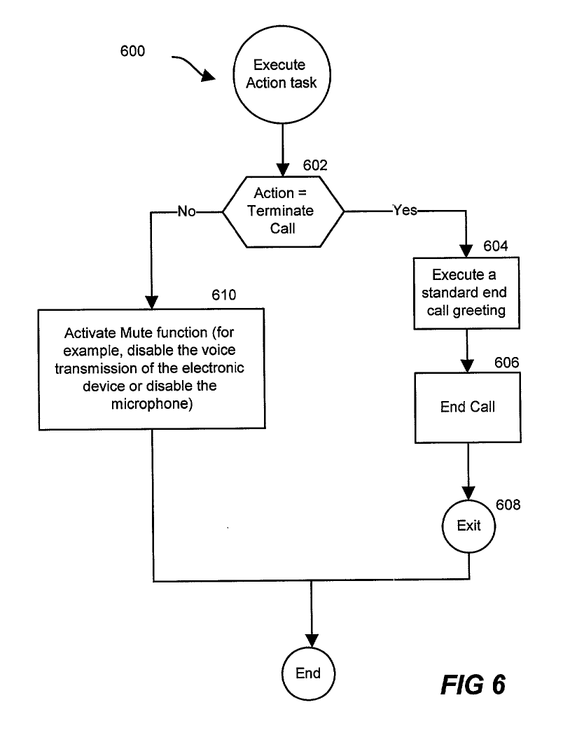

FIG. 6 describes an execute action task 200 accordance to an embodiment of the invention. This task is executed after providing greeting to the called party and is executed from block 310 of the auto notification task 300 described above. At block 602, if the processor determines that action parameter is set to terminate the call, then the call is terminated (depending on the manufacturer, the call may be forwarded to a voice mail box prior to the termination of the call). Otherwise, at block 610, the mute function of the mobile terminal 100 is activated (for example placing the communication link on hold). Generally, the mute function will disable any audio feedback to the calling party. In an exemplary embodiment, activating the mute function will disable the microphone of the mobile terminal 100. Activating the mute function may also disable the voice transmission function may only transmit prerecorded audio file. The activation of the mute function will ignore any audio received at the microphone. Depending on the manufacturer and mobile terminal 100 and setup, prerecorded music may be provided to the calling party while the mute function is active.

As examples, the method and apparatus may also be implemented in electronic devices such as a PDA with wireless communication capabilities, general-purpose computers, and devices having a wireless connection. The method and apparatus may be realized by implementing an operating mode, which may be modified by the user using a menu feature.

Thus, while the invention has been particularly shown and described with respect to preferred embodiments thereof, the above description is intended by way of example only and is not intended to limit the present invention in any way except as set forth in the following claims.

What is claimed is:

1. A method of handling an incoming call request for an electronic device, the incoming call request sent by a calling party and received at the electronic device, the method comprising steps of:
receiving a first input, at the electronic device, by the user in response to the incoming call request;
establishing a communication link in response to receiving said first input;
determining a greeting based on said first input and providing said determined greeting using the communication link to the calling party; and
activating a first function of the electronic device to place said communication link on hold.

2. The method as claimed in claim 1, further comprising the step of:
maintaining the activation of said first function until a second input is received at the electronic device.

3. The method as claimed in claim 2, further comprising the step of:
receiving a second input, at the electronic device, from the user; and
deactivating said first function if determined that said second input indicates an acceptance of said communication link.

4. The method as claimed in claim 3, further comprising the step of providing an end call greeting to the called party and terminating said communication link if determined that said second input indicates termination of said communication link.

5. The method as claimed in claim 2, further comprising the step of:
receiving a second input, at the electronic device, from the calling party; and
activating an alert feature of the electronic device in response to receiving said second input from the calling party.

6. The method as claimed in claim 1, wherein the step of determining said greeting comprises a step of selecting said greeting from a list of greetings.

7. The method as claimed in claim 1, wherein the step of determining said greeting comprises a step of selecting said greeting that is associated with an active profile of the electronic device.

8. The method as claimed in claim 1, wherein the step of determining said greeting comprises a step of selecting said greeting that is associated with an input sequence provided by the user.

9. The method as claimed in claim 1, wherein the step of activating said first function comprises a step of activating a mute function of the electronic device.

10. The method as claimed in claim 1, wherein the step of activating said mute function comprises a step of disabling a microphone function of the electronic device.

11. The method as claimed in claim 1, wherein the step of activating said first function comprises a step of activating said first function substantially upon providing said greeting to the calling party.

12. The method as claimed in claim 1, wherein the step of receiving said first input comprises a step of receiving an input sequence, said input sequence comprises an actuation of a prefix key followed by actuation of at least one suffix key.

13. An electronic device operable in communication system for receiving an incoming call request sent by a calling party, the electronic device comprising:
a processor for receiving a first input by the user in response to the incoming call request and establishing a communication link in response to receiving said first input; said processor further for determining a greeting based on said first input and providing said determined greeting to the calling party; and
said processor further for activating a first function of the electronic device to place said communication link on hold.

14. The electronic device as claimed in claim 13, wherein said processor maintains the activation of said first function until a second input is received.

15. The electronic device as claimed in claim 14, wherein said processor receives a second input from the user using a keypad coupled to said processor and said processor deactivates said first function if said processor determines that said second input indicates an acceptance of said communication link.

16. The electronic device as claimed in claim 15, wherein said processor terminates said communication link if said processor determines that said second input indicates termination of said communication link.

17. The electronic device as claimed in claim 14, wherein said processor receives a second input, at the electronic device, from the calling party and said processor activates an alert feature of the electronic device in response to receiving said second input from the calling party.

18. The electronic device as claimed in claim 13, wherein said processor selects said greeting from a list of pre-defined greetings.

19. The electronic device as claimed in claim 13, wherein said processor selects said greeting that is associated with an active profile of the electronic device.

20. The electronic device as claimed in claim 13, wherein:
said first input comprises an input sequence; and
said processor selects said greeting that is associated with said input sequence.

21. The electronic device as claimed in claim 13, wherein said first function comprises a mute function.

22. The electronic device as claimed in claim 13, wherein said mute function disables a voice transmission of the electronic device.

23. The electronic device as claimed in claim 13, wherein said processor activates said first function substantially upon providing said greeting to the calling party.

24. The electronic device as claimed in claim 13, wherein:
said first input comprises an input sequence; and
said input sequence comprises an actuation of a prefix key followed by actuation of at least one suffix key.

25. A method of handling an incoming call request for an electronic device, the incoming call request sent by a calling party, the method comprising steps of:
receiving a first input, at the electronic device, by the user in response to the incoming call request;
determining a greeting based on said first input and providing said determined greeting to the calling party; and
activating a first function of the electronic device to ignore audio received at a microphone of the electronic device upon providing said determined greeting to the calling party.

26. A method as claimed in claim 25, further comprising the step of activating an alert function upon receiving a second input.
